(19) United States
(12) Patent Application Publication
(10) Pub. No.: US 2025/0234173 A1
(43) Pub. Date: Jul. 17, 2025

(54) INFORMATION COMMUNICATION APPARATUS, INFORMATION COMMUNICATION SYSTEM, INFORMATION COMMUNICATION METHOD, AND STORAGE MEDIUM

(71) Applicant: NEC Corporation, Minato-ku, Tokyo (JP)

(72) Inventors: Kosei KOBAYASHI, Tokyo (JP); Tetsuji KAWATSU, Tokyo (JP); Kazuki OGATA, Tokyo (JP); Yuji SATO, Tokyo (JP); Tetsuya TAKAKI, Tokyo (JP); Jun TAKASAWA, Tokyo (JP); Hiroaki AMINAKA, Tokyo (JP); Kei YANAGISAWA, Tokyo (JP)

(73) Assignee: NEC Corporation, Minato-ku, Tokyo (JP)

(21) Appl. No.: 18/727,974

(22) PCT Filed: Jan. 17, 2022
(86) PCT No.: PCT/JP2022/001281

§ 371 Date: Jul. 10, 2024

(51) Int. Cl. H04W 4/46; G08G 1/0967

(52) U.S. Cl. CPC H04W 4/46; G08G 1/096791

(57) ABSTRACT

In order to make it possible to carry out communication while identifying a vehicle of an intended condition, an information communication apparatus (1) includes: a reception means (11) for receiving a communication request message using wireless communication, the communication request message designating first identification information that identifies a second vehicle which is to be a communication partner of a first vehicle (31) or a server apparatus (40); a determination means (12) for determining, with reference to the first identification information, whether or not the target vehicle is the second vehicle to which a communication request is issued; and a transmission means (13) for transmitting predetermined information possessed by the target vehicle to the first vehicle (31) or the server apparatus (40) in a case where the target vehicle is the second vehicle.

### TECHNICAL FIELD

The present invention relates to an information communication apparatus, an information communication system, an information communication method, and a program.

### BACKGROUND ART

In recent years, vehicle-to-vehicle (V2V) communication and vehicle-to-infrastructure (V2I) communication have become popular, and various kinds of data are exchanged using a vehicle-to-everything (V2X) communication technique. However, PC5 communication of LTE-V2X cannot cope with large-volume data communication such as video information. By using Uu communication such as a fifth-generation mobile communication system (5G), it is possible to carry out large-volume data communication. However, it is impossible to carry out communication unless information (e.g., connection destination information) for identifying a partner vehicle is known.

Patent Literature 1 indicates that a management apparatus transmits, to an in-vehicle apparatus of a vehicle, positional information of a section where traffic jam occurs or an in-vehicle apparatus present in a section where traffic jam occurs, and information pertaining to a network address or the like. Then, the in-vehicle apparatus of the vehicle selects, based on the positional information acquired from the management apparatus, a candidate camera as a candidate for camera video distribution.

Patent Literature 2 discloses selecting, from among a plurality of vehicles, a vehicle which is currently in the vicinity of a position where a user wishes to take an image or a vehicle whose planned travelling route overlaps with the vicinity of a position where a user wishes to take an image.

### CITATION LIST

### Patent Literature

### [Patent Literature 1]

Japanese Patent Application Publication, Tokukai, No. 2021-056191

### [Patent Literature 2]

Japanese Patent Application Publication, Tokukai, No. 2013-187877

### SUMMARY OF INVENTION

### Technical Problem

As described above, in order to carry out large-volume data communication using Uu communication such as 5G, information for identifying a partner vehicle (in-vehicle apparatus) is necessary. In Patent Literature 1, it is possible to transmit, to an in-vehicle apparatus of a vehicle, positional information of a section where traffic jam occurs or an in-vehicle apparatus present in a section where traffic jam occurs, and information pertaining to a network address or the like. However, there is a possibility that it is impossible to identify an in-vehicle apparatus of a vehicle of an intended condition.

In Patent Literature 2, it is possible to select, from among a plurality of vehicles, a vehicle which is currently in the vicinity of a position where a user wishes to take an image, or the like. However, similarly to Patent Literature 1, there is a possibility that it is impossible to identify an in-vehicle apparatus of a vehicle of an intended condition.

An example aspect of the present invention is accomplished in view of the above problems, and an example object thereof is to provide a technique which makes it possible to carry out communication while identifying a vehicle of an intended condition.

### Solution to Problem

An information communication apparatus in accordance with an example aspect of the present invention is mounted on a target vehicle, the information communication apparatus including: a reception means for receiving a communication request message using wireless communication, the communication request message designating first identification information that identifies a second vehicle which is to be a communication partner of a first vehicle or a server apparatus; a determination means for determining, with reference to the first identification information, whether or not the target vehicle is the second vehicle to which a communication request is issued; and a transmission means for transmitting predetermined information possessed by the target vehicle to the first vehicle or the server apparatus in a case where the target vehicle is the second vehicle.

An information communication system in accordance with an example aspect of the present invention includes: an information communication apparatus which is mounted on a target vehicle; a first transmission means for transmitting a communication request message using broadcast wireless communication, the communication request message designating first identification information that identifies a second vehicle which is to be a communication partner of a first vehicle or a server apparatus; a determination means for determining, with reference to the first identification information, whether or not the target vehicle is the second vehicle to which a communication request is issued; and a second transmission means for transmitting predetermined information possessed by the target vehicle to the first vehicle or the server apparatus in a case where the target vehicle is the second vehicle.

An information communication method in accordance with an example aspect of the present invention includes: transmitting a communication request message using broadcast wireless communication, the communication request message designating first identification information that identifies a second vehicle which is to be a communication partner of a first vehicle or a server apparatus; determining, with reference to the first identification information, whether or not the target vehicle is the second vehicle to which a communication request is issued; and transmitting predetermined information possessed by the target vehicle to the first vehicle or the server apparatus in a case where the target vehicle is the second vehicle.

A program in accordance with an example aspect of the present invention causes a computer to carry out: a process of receiving a communication request message using wireless communication, the communication request message designating first identification information that identifies a second vehicle which is to be a communication partner of a first vehicle or a server apparatus; a process of determining, with reference to the first identification information, whether or not the target vehicle is the second vehicle to which a communication request is issued; and a process of transmitting predetermined information possessed by the target vehicle to the first vehicle or the server apparatus in a case where the target vehicle is the second vehicle.

### Advantageous Effects of Invention

According to an example aspect of the present invention, it is possible to carry out communication while identifying a vehicle of an intended condition.

### BRIEF DESCRIPTION OF DRAWINGS

FIG. 1 is a diagram illustrating, with example vehicle and server apparatus, a configuration of an information communication apparatus in accordance with a first example embodiment of the present invention.

FIG. 2 is a diagram for describing an example of first identification information that identifies a second vehicle.

FIG. 3 is a flowchart illustrating a flow of an information communication method carried out by the information communication apparatus in accordance with the first example embodiment of the present invention.

FIG. 4 is a block diagram illustrating a configuration of an information communication system in accordance with the first example embodiment of the present invention.

FIG. 5 is a flowchart illustrating a flow of an information communication method carried out by the information communication system in accordance with the first example embodiment of the present invention.

FIG. 6 is a diagram illustrating a configuration of an information communication apparatus in accordance with a second example embodiment of the present invention.

FIG. 7 is a diagram illustrating a configuration of an information communication system in accordance with a third example embodiment of the present invention.

FIG. 8 is a flowchart illustrating a flow of an information communication method carried out by the information communication system in accordance with the third example embodiment of the present invention.

FIG. 9 is a block diagram illustrating a configuration of a computer that functions as an information communication apparatus or an information communication system in accordance with each example embodiment.

### EXAMPLE EMBODIMENTS

### First Example Embodiment

The following description will discuss a first example embodiment of the present invention in detail, with reference to the drawings. The present example embodiment is a basic form of example embodiments described later. Note that reference signs which are indicated in the drawings and are used in this overview are given to elements for convenience as an example for assisting in understanding, and are not intended to limit the present invention to the illustrated aspects. The connection lines between blocks in the drawings and the like referred to in the descriptions below include both a bidirectional relation and a unidirectional relation. The one-way arrow schematically indicates a flow of a main signal (data), and does not exclude bidirectionality. The connection point of an input and an output of each of the blocks in the drawings may be configured to include a port or an interface. The configurations of these are not illustrated.

<Information Communication Apparatus 1 in Accordance with First Example Embodiment>

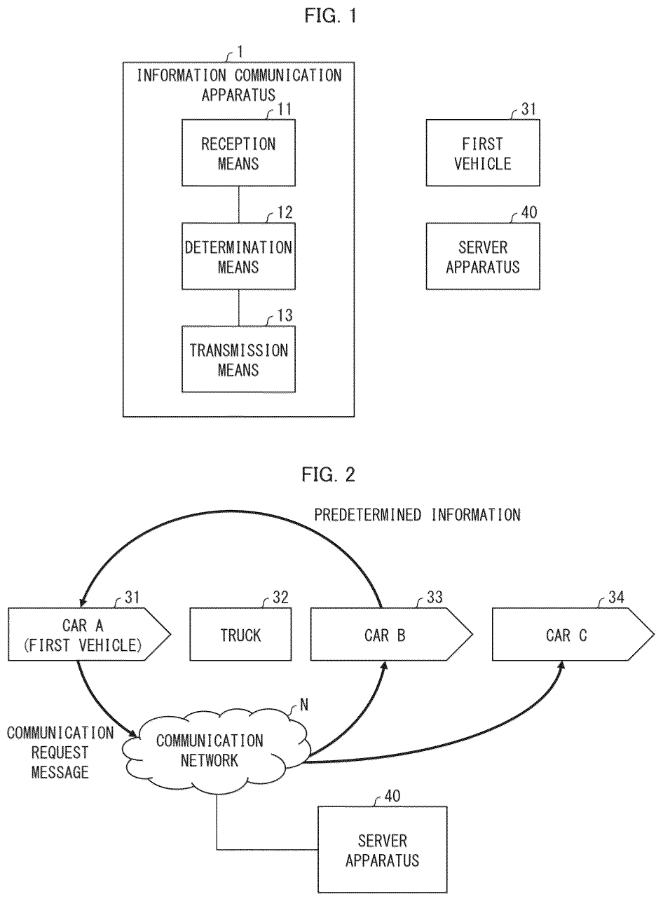

FIG. 1 is a diagram illustrating, with example vehicle and server apparatus, a configuration of an information communication apparatus 1 in accordance with the first example embodiment of the present invention. The information communication apparatus 1 is mounted on each of a plurality of vehicles including a target vehicle. Here, the target vehicle refers to all vehicles each of which is mounted with the information communication apparatus 1 and which are in a V2X service area. The information communication apparatus 1 in accordance with the present example embodiment includes, as illustrated in FIG. 1, a reception means 11, a determination means 12, and a transmission means 13.

The first vehicle 31 is a vehicle which intends to acquire, from the second vehicle, predetermined information possessed by the second vehicle, and transmits a communication request message that designates first identification information which identifies the second vehicle. For example, the first vehicle 31 transmits a communication request message to all vehicles in the V2X service area using C-V2X broadcast communication.

C-V2X of LTE (LTE V2X) and C-V2X of 5G (NR V2X) each include two types of communication modes, i.e., direct communication (PC5 communication) and indirect communication (Uu communication). The Uu communication is a mode for carrying out communication via a base station, and is carried out by an ordinary smart phone or the like. Note that the Uu communication is unicast-type communication and is sometimes referred to as vehicle-to-network (V2N) communication.

The PC5 communication is a mode in which direct communication is carried out between vehicles and between vehicles and infrastructure without using a base station therebetween. Such types of communication are sometimes referred to as V2V communication and V2I communication. The PC5 communication is generally broadcast-type communication, and is not suitable for large-volume communication due to restrictions on bandwidth and wireless protocol specifications.

One example object of the present invention is to acquire a Uu communication address of a communication partner using PC5 broadcast communication, and carry out large-volume communication by Uu communication using the acquired communication address. Hereinafter, unless otherwise specified, the simple term “C-V2X” refers to PC5 communication.

Note that, instead of the PC5 communication, it is possible to use dedicated short range communications (DSRC), which is a wireless-LAN-based vehicle-to-vehicle communication technique. The DSRC is also a broadcast-type communication. In the DSRC, for example, identification information is transmitted in a DSRC broadcast, and communication address information for Uu communication of LTE/5G is acquired from a target vehicle.

In a case where the server apparatus 40 intends to acquire, from the second vehicle, predetermined information possessed by the second vehicle, the server apparatus 40 transmits a communication request message that designates first identification information which identifies the second vehicle. For example, the server apparatus 40 transmits a communication request message to all vehicles in the V2X service area using C-V2X broadcast communication.

The reception means 11 receives a communication request message using wireless communication, the communication request message designating first identification information that identifies a second vehicle which is to be a communication partner of the first vehicle 31 or the server apparatus 40. For example, the reception means 11 receives a communication request message from the first vehicle 31 or the server apparatus 40 using C-V2X.

In the PC5 communication of C-V2X, communication is basically carried out by broadcast communication. Therefore, in a case of carrying out communication with a specific vehicle or server apparatus, broadcast communication designating the specific vehicle or server apparatus is carried out.

Examples of data exchanged by the V2X communication technique include road traffic information, data pertaining to a behavior of an automobile, data pertaining to formation and follow-up travelling, data pertaining to automatic driving, and the like. In the present example embodiment, among these pieces of data, it is possible to utilize data pertaining to a behavior of an automobile, in particular, information on a travelling area, positional information, a travelling speed, and a travelling distance of the automobile, driving characteristics such as acceleration and deceleration and steering, a status of the automobile, and the like.

The first identification information is information for identifying a second vehicle which is to be a communication partner of the first vehicle 31 or the server apparatus 40. For example, the first identification information is characteristic information indicating a characteristic of a second vehicle, positional information of a second vehicle, or the like.

FIG. 2 is a diagram for describing an example of first identification information for identifying a second vehicle. In FIG. 2, the first vehicle corresponds to a car A 31. At least a car B 33 and a car C 34 are each mounted with the information communication apparatus 1 in accordance with the present example embodiment. The second vehicle corresponds to the car B 33 or the car C 34.

A truck 32 is present in front of the car A 31, which is the first vehicle, in a traveling direction and, when seen from a driver of the car A 31, sight in front of the truck 32 is obstructed. In a case where the driver of the car A 31 wants an image in front of the truck 32, the first identification information is characteristic information indicating a characteristic of the car B 33 or the car C 34 which has an image in front of the truck 32, positional information, or the like. The driver of the car A 31 transmits, using the in-vehicle terminal, a communication request message designating first identification information via a communication network N using broadcast communication. The communication network N is, for example, V2X, a fifth-generation mobile communication system (5G) core network or a fourth-generation mobile communication system (4G) core network that is defined by the third-generation mobile communication system partnership project (3GPP), or the like.

The determination means 12 determines, with reference to the first identification information, whether or not the target vehicle is a second vehicle to which a communication request is issued. For example, the information communication apparatus 1 has characteristic information of a vehicle (target vehicle) on which the information communication apparatus 1 is mounted, and the determination means 12 determines whether or not the target vehicle is the second vehicle based on whether or not the first identification information conforms to the characteristic information of the target vehicle. For example, in a case where the first identification information is a body color of a vehicle, it is determined whether or not the target vehicle is the second vehicle based on whether or not the first identification information conforms to characteristic information (body color) of the target vehicle.

In a case where the target vehicle is the second vehicle, the transmission means 13 transmits, to the first vehicle 31 or the server apparatus 40, predetermined information possessed by the target vehicle. The predetermined information possessed by the target vehicle is, for example, communication connection information of the information communication apparatus 1 which is mounted on the target vehicle. Examples of the communication connection information include, but not limited to, an IP address and the like. The communication connection information only needs to be information with which a communication partner can be identified.

Transmission of predetermined information possessed by a specific vehicle by the transmission means 13 can be unicast communication or broadcast communication. For example, in a case where a transmission source IP address of the communication request message is included in a header portion or a data portion of the communication request message, the predetermined information may be transmitted to the IP address by unicast communication.

In a case where an identifier of the communication request message is included in a header portion or a data portion of the communication request message, the predetermined information may be transmitted by broadcast communication with information indicating that the predetermined information is a response to the identifier.

In a case where the communication request message includes communication connection information of the first vehicle 31, the information communication apparatus 1 can carry out communication with the first vehicle 31 using a communication network such as 5G or 4G.

In a case where the predetermined information possessed by the target vehicle is an image which has been taken by an imaging apparatus that is mounted on the target vehicle, the information communication apparatus 1 can carry out large-volume data communication (such as video information) with the first vehicle 31 using a communication network such as 5G or 4G. Therefore, the car A 31 can acquire a video in front of the truck 32.

<Example Advantage of Information Communication Apparatus 1 in Accordance with First Example Embodiment>

As described above, according to the information communication apparatus 1 in accordance with the present example embodiment, the determination means 12 determines, with reference to the first identification information, whether or not the target vehicle is the second vehicle to which a communication request is issued. Then, in a case where the target vehicle is the second vehicle, the transmission means 13 transmits, to the first vehicle 31 or the server apparatus 40, predetermined information possessed by the target vehicle. As such, by transmitting, from the first vehicle 31 or the server apparatus 40, a communication request message that designates first identification information which identifies the second vehicle, it is possible to carry out communication while identifying a vehicle of an intended condition.

### <Flow of Information Communication Method by Information Communication Apparatus 1>

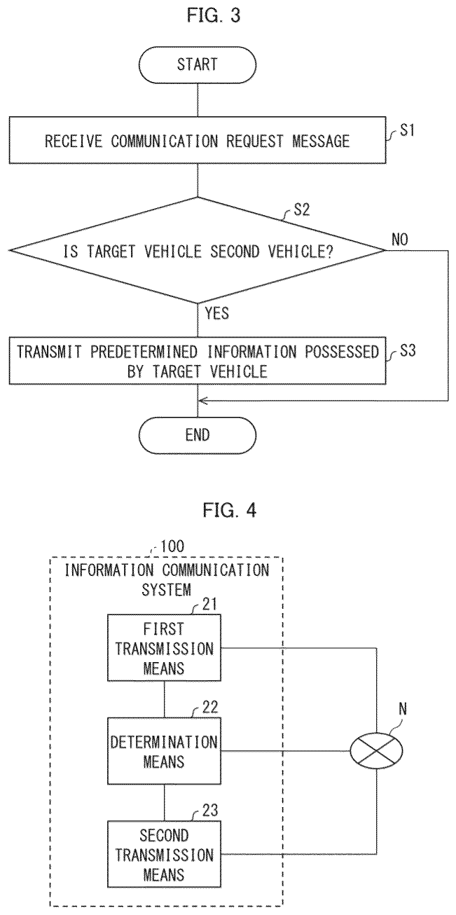

The following description will discuss a flow of an information communication method that is carried out by the information communication apparatus 1 configured as described above, with reference to FIG. 3. FIG. 3 is a flowchart illustrating a flow of an information communication method carried out by the information communication apparatus 1 in accordance with the first example embodiment of the present invention. As illustrated in FIG. 3, the information communication method includes steps S1 through S3.

First, the reception means 11 receives a communication request message using wireless communication, the communication request message designating first identification information that identifies a second vehicle which is to be a communication partner of the first vehicle 31 or the server apparatus 40 (S1). For example, the reception means 11 receives a communication request message from the first vehicle 31 or the server apparatus 40 using C-V2X.

Next, the determination means 12 determines, with reference to the first identification information, whether or not the target vehicle is a second vehicle to which a communication request is issued (S2). For example, the information communication apparatus 1 has characteristic information of a vehicle (target vehicle) on which the information communication apparatus 1 is mounted, and the determination means 12 determines whether or not the target vehicle is the second vehicle based on whether or not the first identification information conforms to the characteristic information of the target vehicle. In a case where the target vehicle is not the second vehicle (S2, No), the process ends.

In a case where the target vehicle is the second vehicle (S2, Yes), the transmission means 13 transmits, to the first vehicle 31 or the server apparatus 40, predetermined information possessed by the target vehicle (S3). The predetermined information possessed by the target vehicle is, for example, communication connection information of the information communication apparatus 1 which is mounted on the target vehicle.

<Example Advantage of Information Communication Method by Information Communication Apparatus 1 in Accordance with First Example Embodiment>

As described above, according to the information communication method carried out by the information communication apparatus 1 in accordance with the present example embodiment, whether or not the target vehicle is the second vehicle to which a communication request is issued is determined with reference to the first identification information, and in a case where the target vehicle is the second vehicle, predetermined information possessed by the target vehicle is transmitted to the first vehicle 31 or the server apparatus 40. As such, by transmitting, from the first vehicle 31 or the server apparatus 40, a communication request message that designates first identification information which identifies the second vehicle, it is possible to carry out communication while identifying a vehicle of an intended condition.

### <Configuration of Information Communication System 100>

The following description will discuss a configuration of an information communication system 100 in accordance with the present example embodiment, with reference to FIG. 4. FIG. 4 is a block diagram illustrating a configuration of the information communication system 100 in accordance with the first example embodiment of the present invention. The information communication system 100 is an information communication system including an information communication apparatus 1 which is mounted on a target vehicle. As illustrated in FIG. 4, the information communication system 100 includes a first transmission means 21, a determination means 22, and a second transmission means 23.

The first transmission means 21, the determination means 22, and the second transmission means 23 are configured to be communicable with each other via, for example, a network N. Here, a specific configuration of the network N does not limited the present example embodiment and, as an example, it is possible to employ the foregoing V2X, 5G core network, 4G core network, or the like.

The first transmission means 21 is, for example, disposed in the foregoing first vehicle 31 or server apparatus 40, and transmits, using broadcast wireless communication, a communication request message designating first identification information that identifies a second vehicle which is to be a communication partner of the first vehicle 31 or the server apparatus 40. The first vehicle 31 and the server apparatus 40 are a vehicle and an apparatus which intend to acquire, from the second vehicle, predetermined information possessed by the second vehicle, and each transmit a communication request message that designates first identification information which identifies the second vehicle.

The determination means 22 is, for example, disposed in the foregoing information communication apparatus 1, and determines, with reference to the first identification information, whether or not the target vehicle is the second vehicle to which a communication request is issued. For example, the information communication apparatus 1 has characteristic information of a vehicle (target vehicle) on which the information communication apparatus 1 is mounted, and the determination means 22 determines whether or not the target vehicle is the second vehicle based on whether or not the first identification information conforms to the characteristic information of the target vehicle.

The second transmission means 23 is, for example, disposed in the foregoing information communication apparatus 1. In a case where the target vehicle is the second vehicle, the second transmission means 23 transmits predetermined information possessed by the target vehicle to the first vehicle 31 or the server apparatus 40. The predetermined information possessed by the target vehicle is, for example, communication connection information of the information communication apparatus 1 which is mounted on the target vehicle.

### <Flow of Information Communication Method by Information Communication System 100>

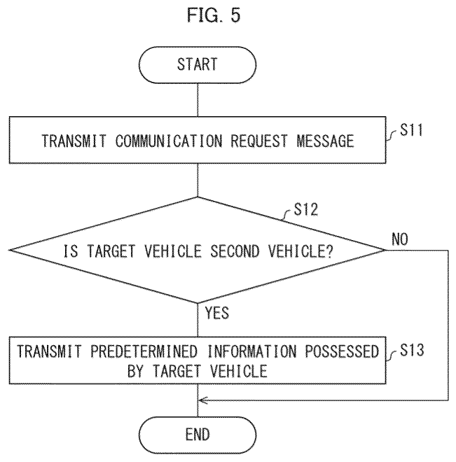

The following description will discuss a flow of an information communication method that is carried out by the information communication system 100 configured as described above, with reference to FIG. 5. FIG. 5 is a flowchart illustrating a flow of an information communication method carried out by the information communication system 100 in accordance with the first example embodiment of the present invention. As illustrated in FIG. 5, the information communication method includes steps S11 through S13.

First, the first transmission means 21 transmits, using broadcast wireless communication, a communication request message designating first identification information that identifies a second vehicle which is to be a communication partner of the first vehicle 31 or the server apparatus 40 (S11). For example, the first transmission means 21 transmits a communication request message to all vehicles in the V2X service area using C-V2X broadcast communication.

Next, the determination means 22 determines, with reference to the first identification information, whether or not the target vehicle is a second vehicle to which a communication request is issued (S12). For example, the information communication apparatus 1 has characteristic information of a vehicle (target vehicle) on which the information communication apparatus 1 is mounted, and the determination means 22 determines whether or not the target vehicle is the second vehicle based on whether or not the first identification information conforms to the characteristic information of the target vehicle. In a case where the target vehicle is not the second vehicle (S12, No), the process ends.

In a case where the target vehicle is the second vehicle (S12, Yes), the second transmission means 23 transmits, to the first vehicle 31 or the server apparatus 40, predetermined information possessed by the target vehicle (S13). The predetermined information possessed by the target vehicle is, for example, communication connection information of the information communication apparatus 1 which is mounted on the target vehicle.

<Example Advantage of Information Communication System 100 in Accordance with First Example Embodiment>

As described above, according to the information communication system 100 in accordance with the present example embodiment, the determination means 22 determines, with reference to the first identification information, whether or not the target vehicle is the second vehicle to which a communication request is issued. Then, in a case where the target vehicle is the second vehicle, the second transmission means 23 transmits, to the first vehicle 31 or the server apparatus 40, predetermined information possessed by the target vehicle. As such, by transmitting, from the first transmission means 21, a communication request message that designates first identification information which identifies the second vehicle, it is possible to carry out communication while identifying a vehicle of an intended condition.

### Second Example Embodiment

The following description will discuss a second example embodiment of the present invention in detail, with reference to the drawings. The same reference numerals are given to constituent elements which have functions identical with those described in the first example embodiment, and descriptions as to such constituent elements are omitted as appropriate.

<Information Communication Apparatus 1A in Accordance with Second Example Embodiment>

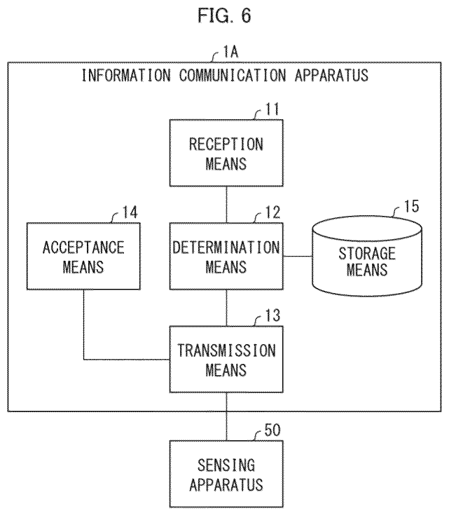

FIG. 6 is a diagram illustrating a configuration of an information communication apparatus 1A in accordance with the second example embodiment of the present invention. The information communication apparatus 1A in accordance with the present example embodiment includes, as illustrated in FIG. 6, a reception means 11, a determination means 12, a transmission means 13, an acceptance means 14, and a storage means 15.

The reception means 11 receives a communication request message using wireless communication, the communication request message designating first identification information that identifies a second vehicle which is to be a communication partner of the first vehicle 31 or the server apparatus 40. For example, the reception means 11 receives a communication request message from the first vehicle 31 or the server apparatus 40 using C-V2X.

The first identification information includes at least one item selected from the group consisting of license plate information, a vehicle type, and a body color of the second vehicle.

In the storage means 15, at least one item selected from the group consisting of license plate information, a vehicle type, and a body color is preregistered as characteristic information of a target vehicle.

The determination means 12 determines whether or not the target vehicle is the second vehicle based on whether or not at least one item of the first identification information conforms to preregistered information. For example, in a case where the first identification information indicates a body color of a vehicle, the determination means 12 determines whether or not the target vehicle is the second vehicle based on whether or not the first identification information conforms to characteristic information (body color) of the target vehicle which is preregistered in the storage means 15.

In a case where the first identification information is license plate information of the target vehicle, the determination means 12 determines whether or not the target vehicle is the second vehicle based on whether or not the first identification information partially or entirely conforms to license plate information of the target vehicle which is preregistered in the storage means 15.

In a case where the first identification information is positional information of the second vehicle, the determination means 12 determines whether or not the target vehicle is the second vehicle based on whether or not positional information of the target vehicle conforms to positional information of the second vehicle. For example, the information communication apparatus 1 can acquire, using V2X, positional information of a vehicle which is present in the V2X service area. Therefore, the information communication apparatus 1 can acquire positional information of the target vehicle. The determination means 12 determines whether or not the target vehicle is the second vehicle based on whether or not the acquired positional information of the target vehicle conforms to positional information of the second vehicle which is the first identification information. In a case where a distance between a position indicated by one piece of positional information and a position indicated by the other piece of positional information is equal to or shorter than a predetermined distance, those pieces of positional information are determined to conform to each other.

As described above, conformity between pieces of positional information is not limited to a case of complete conformity. For example, in a case where a difference between positional information of the target vehicle and positional information of the second vehicle is equal to or less than a predetermined value, such pieces of positional information may be regarded to conform to each other. The predetermined value may be decided based on a speed of the second vehicle. Specifically, as the speed of the second vehicle increases, the predetermined value may be set greater. Furthermore, a moving direction may be further taken into consideration. This is to determine whether a direction of the error conforms to the vehicle traveling direction.

The acceptance means 14 accepts selection by a user. The acceptance means 14 is constituted by, for example, an input device such as a keyboard, and accepts selection by the user as to whether or not to accede to a communication request message.

In a case where the determination means 12 has determined that the target vehicle is the second vehicle and the user has selected, with the acceptance means 14, to accede to the communication request message, the transmission means 13 transmits predetermined information possessed by the target vehicle. In a case where the determination means 12 has determined that the target vehicle is the second vehicle but the user has selected, with the acceptance means 14, not to accede to the communication request message, the transmission means 13 does not transmit predetermined information possessed by the target vehicle.

In the above description, the transmission means 13 carries out the determination process of determining whether or not to transmit predetermined information in accordance with the above conditions. However, for example, the determination means 12 may carry out this determination process.

The predetermined information possessed by the target vehicle is, for example, communication connection information of the target vehicle in the wireless communication. Upon receipt of communication connection information from the car B 33 or the car C 34, which is a target vehicle, the in-vehicle terminal of the car A 31 can carry out large-volume data communication (such as video information) with the car B 33 or the car C 34 using a communication network such as 5G or 4G. Therefore, the car A 31 can acquire a video in front of the truck 32.

The predetermined information possessed by the target vehicle may be sensing information which has been acquired by a sensing apparatus 50 that is mounted on the target vehicle. Examples of the sensing apparatus 50 include a visible light camera, an infrared sensor, an ultrasonic sensor, a light detection and ranging (LiDAR), a millimeter-wave radar, and the like. In a case where the sensing apparatus 50 is an imaging apparatus such as a visible light camera, the transmission means 13 transmits, to the first vehicle 31, image information which has been obtained by the imaging apparatus.

<Example Advantage of Information Communication Apparatus 1A in Accordance with Second Example Embodiment>

As described above, according to the information communication apparatus 1A in accordance with the present example embodiment, the determination means 12 determines whether or not the target vehicle is the second vehicle based on whether or not at least one item of the first identification information (license plate information, a vehicle type, and a body color of the second vehicle) conform to preregistered information. Therefore, the first vehicle 31 transmits a communication request message that designates first identification information which represents a characteristic of the second vehicle, and it is thus possible to carry out communication while identifying a vehicle of an intended condition.

The determination means 12 determines whether or not the target vehicle is the second vehicle based on whether or not positional information of the target vehicle conforms to positional information of the second vehicle. Therefore, the first vehicle 31 transmits a communication request message that designates positional information of the second vehicle, and it is thus possible to carry out communication while identifying a vehicle of an intended condition.

In a case where the target vehicle is the second vehicle but the user has selected not to accede to the communication request message, the transmission means 13 does not transmit predetermined information possessed by the target vehicle. Therefore, a user of the target vehicle can decide whether or not to accede to the communication request message.

The predetermined information possessed by the target vehicle is communication connection information of the target vehicle in the wireless communication. Therefore, the first vehicle 31 can carry out large-volume data communication with the target vehicle.

The predetermined information possessed by the target vehicle is sensing information which has been acquired by the sensing apparatus 50 that is mounted on the target vehicle. Therefore, even in a case where there is a vehicle which obstructs sight in front of the first vehicle 31, it is possible to acquire information pertaining to the front of the vehicle which obstructs the sight.

### Variation of Second Example Embodiment

The following description will discuss a variation of the second example embodiment of the present invention in detail, with reference to the drawings. The same reference numerals are given to constituent elements which have functions identical with those described in the second example embodiment, and descriptions as to such constituent elements are omitted as appropriate.

The second example embodiment employs the configuration in which the reception means 11 receives a communication request message designating first identification information that identifies a second vehicle which is to be a communication partner of the first vehicle 31 or the server apparatus 40. In this variation, a configuration is employed in which the reception means 11 receives a communication request message designating first identification information and second identification information that identify a second vehicle which is to be a communication partner of the first vehicle 31 or the server apparatus 40. Note that this variation will be described with reference to FIG. 6.

The communication request message further includes second identification information pertaining to a behavior of the second vehicle. The second identification information is, for example, information pertaining to behaviors of a vehicle such as a left turn, a right turn, a stop, and a straight travelling. For example, in a case where the first identification information indicates that the body color is “red” and the second identification information indicates a “right turn” of the vehicle, information for identifying the second vehicle is “a red vehicle which has made a right turn”.

The information communication apparatus 1A can acquire information pertaining to a behavior of the target vehicle by referring to V2X information. For example, in a case where the information communication apparatus 1A has acquired operation information indicating blinking of a blinker of the target vehicle and/or operation information of a steering wheel, the determination means 12 can determine a right turn or a left turn of the target vehicle. In a case where the information communication apparatus 1A has acquired speed information of the target vehicle, the determination means 12 can determine whether or not the target vehicle is stopped.

The identification information may include lane information of a lane (e.g., a first travelling lane, a second travelling lane, an overtaking lane, or the like) on which the second vehicle is traveling. The lane information may be included in the first identification information or may be included in the second identification information. The lane information may be set as third identification information, and the determination means 12 may determine whether or not the target vehicle is the second vehicle based on the first identification information, the second identification information, and the third identification information.

The determination means 12 determines whether or not the target vehicle is the second vehicle based on a combination of the first identification information and the second identification information. For example, in a case where the first identification information indicates that the body color is “red” and the second identification information indicates a “right turn” of the vehicle, the determination means 12 first determines, with reference to the first identification information, whether or not the body color of the target vehicle is “red”.

In a case where the body color of the target vehicle is “red”, the determination means 12 determines, with reference to a history of V2X information, whether or not the target vehicle has made a right turn within a predetermined period of time. Note that pieces of information pertaining to behaviors of the target vehicle have been accumulated in the storage means 15, and the determination means 12 can refer to a history of the behaviors of the target vehicle.

In a case where the determination means 12 has determined that the target vehicle is a “red vehicle which has made a right turn” and the user has selected to accede to the communication request message, the transmission means 13 transmits, to the first vehicle 31, predetermined information possessed by the target vehicle.

<Example Advantage of Information Communication Apparatus 1A in Accordance with Variation of Second Example Embodiment>

As described above, according to the information communication apparatus 1A in accordance with this variation, the determination means 12 determines whether or not the target vehicle is the second vehicle based on a combination of the first identification information and the second identification information. Therefore, it is possible to designate a vehicle of an intended condition in more detail.

### Third Example Embodiment

The following description will discuss a third example embodiment of the present invention in detail, with reference to the drawings. The same reference numerals are given to constituent elements which have functions identical with those described in the first example embodiment, and descriptions as to such constituent elements are omitted as appropriate.

<Information Communication System 100A in Accordance with Third Example Embodiment>

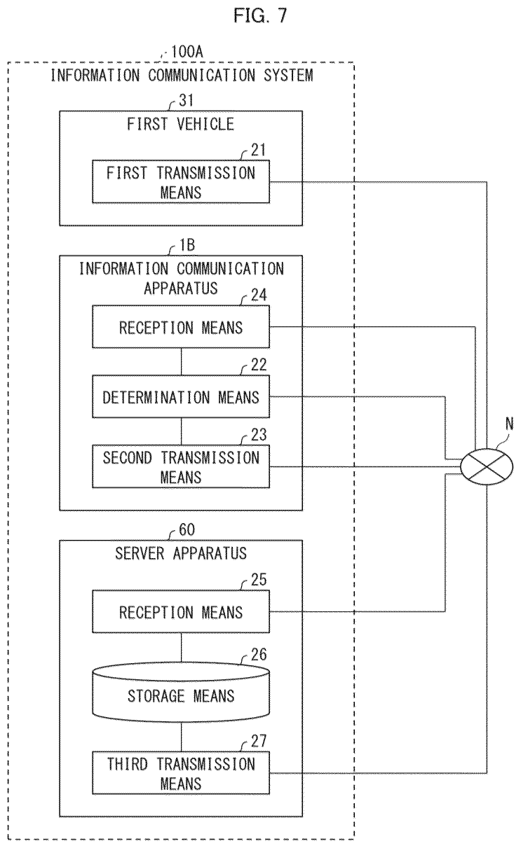

FIG. 7 is a diagram illustrating a configuration of an information communication system 100A in accordance with the third example embodiment of the present invention. The information communication system 100A in accordance with the present example embodiment includes, as illustrated in FIG. 7, an information communication apparatus 1B, a server apparatus 60, and a first vehicle 31.

The first vehicle 31 includes a first transmission means 21. The information communication apparatus 1B includes a reception means 24, a determination means 22, and a second transmission means 23. The server apparatus 60 includes a reception means 25, a storage means 26, and a third transmission means 27. The first transmission means 21, the reception means 24 and 25, the determination means 22, the second transmission means 23, and the third transmission means 27 are configured to be communicable with each other via, for example, a network N. Here, a specific configuration of the network N does not limited the present example embodiment and, as an example, it is possible to employ the foregoing V2X, 5G core network, 4G core network, or the like.

The first transmission means 21 of the first vehicle 31 transmits, using broadcast wireless communication, a communication request message designating first identification information that identifies a second vehicle which is to be a communication partner of the first vehicle 31.

The reception means 24 of the information communication apparatus 1B receives a communication request message using wireless communication, the communication request message designating first identification information that identifies a second vehicle which is to be a communication partner of the first vehicle 31. For example, the reception means 11 receives a communication request message from the first vehicle 31 or the server apparatus 60 using C-V2X.

The determination means 22 determines, with reference to the first identification information, whether or not the target vehicle is a second vehicle to which a communication request is issued. For example, the information communication apparatus 1 has characteristic information of a vehicle (target vehicle) on which the information communication apparatus 1 is mounted, and the determination means 22 determines whether or not the target vehicle is the second vehicle based on whether or not the first identification information conforms to the characteristic information of the target vehicle.

In a case where the target vehicle is the second vehicle, the second transmission means 23 of the information communication apparatus 1B transmits, to the first vehicle 31 or the server apparatus 40, predetermined information possessed by the target vehicle. The predetermined information possessed by the target vehicle is, for example, communication connection information of the information communication apparatus 1 which is mounted on the target vehicle.

The storage means 26 of the server apparatus 60 stores pieces of first identification information corresponding to respective vehicles included in a vehicle group and pieces of communication connection information of the respective vehicles in association with each other.

The reception means 25 of the server apparatus 60 receives, from the first vehicle 31, a communication request message designating a piece of first identification information which identifies the second vehicle.

In a case where the storage means 26 of the server apparatus 60 stores a piece of first identification information included in the communication request message which has been received by the reception means 25, the third transmission means 27 acquires a piece of communication connection information corresponding to the second vehicle from the storage means 26, and transmits the piece of communication connection information to the first vehicle or the server apparatus 40.

In a case where the storage means 26 does not store a piece of first identification information included in the communication request message which has been received by the reception means 25, the third transmission means 27 transfers the communication request message using broadcast wireless communication.

In this case, the reception means 25 receives, from the second vehicle, a piece of communication connection information corresponding to the second vehicle, and the storage means 26 stores the piece of communication connection information corresponding to the second vehicle in association with the piece of first identification information which identifies the second vehicle.

### <Flow of Information Communication Method by Information Communication System 100A>

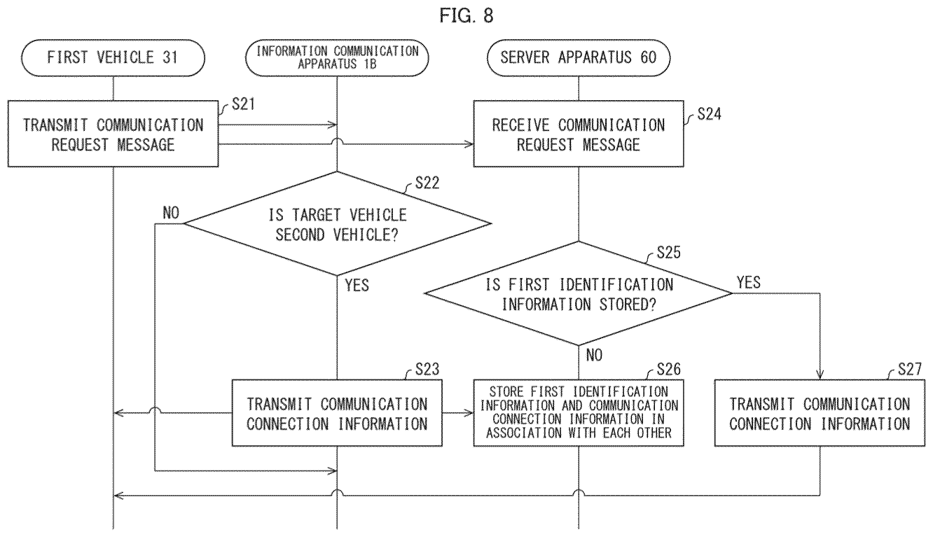

The following description will discuss a flow of an information communication method that is carried out by the information communication system 100A configured as described above, with reference to FIG. 8. FIG. 8 is a flowchart illustrating a flow of an information communication method carried out by the information communication system 100A in accordance with the third example embodiment of the present invention. As illustrated in FIG. 8, the information communication method includes steps S21 through S27.

First, the first transmission means 21 of the first vehicle 31 transmits, using broadcast wireless communication, a communication request message designating first identification information that identifies a second vehicle which is to be a communication partner of the first vehicle 31 (S21). For example, the first transmission means 21 transmits a communication request message using C-V2X broadcast communication.

Next, the determination means 22 of the information communication apparatus 1B determines, with reference to the first identification information included in the communication request message which has been received by the reception means 24, whether or not the target vehicle is the second vehicle to which a communication request is issued (S22). In a case where the target vehicle is not the second vehicle (S22, No), the process ends. In a case where the target vehicle is the second vehicle (S22, Yes), the second transmission means 23 transmits, to the first vehicle 31 and the server apparatus 60, communication connection information of the target vehicle (S23).

In a case where the reception means 25 of the server apparatus 60 has received the communication request message from the first vehicle 31 (S24), then the reception means 25 determines whether or not the first identification information included in the communication request message is stored in the storage means 26 (S25). In a case where the storage means 26 stores the first identification information included in the communication request message (S25, Yes), the third transmission means 27 acquires communication connection information corresponding to the second vehicle from the storage means 26, and transmits the communication connection information to the first vehicle (S27).

In a case where the storage means 26 does not store the first identification information included in the communication request message (S25, No), the storage means 26 stores communication connection information corresponding to the second vehicle in association with the first identification information which identifies the second vehicle (S26).

<Example Advantage of Information Communication System 100A in Accordance with Third Example Embodiment>

As described above, according to the information communication system 100A in accordance with the present example embodiment, in a case where the storage means 26 stores first identification information corresponding to the second vehicle, the third transmission means 27 acquires communication connection information corresponding to the second vehicle from the storage means 26, and transmits the communication connection information to the first vehicle or the server apparatus 40. Therefore, the second transmission means 23 of the information communication apparatus 1B does not need to transmit communication connection information to the first vehicle 31 or the server apparatus 40, and this makes it possible to shorten a processing time.

### <Software Implementation Example>

The functions of part of or all of the information communication apparatuses 1, 1A, and 1B and the information communication systems 100 and 100A can be realized by hardware such as an integrated circuit (IC chip) or can be alternatively realized by software.

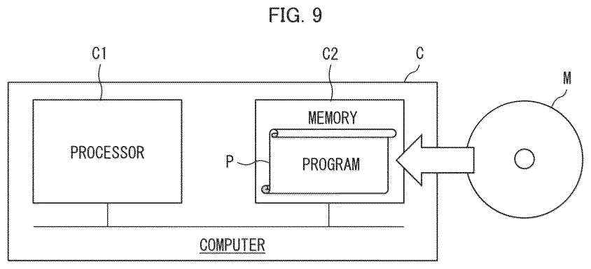

In the latter case, each of the information communication apparatuses 1, 1A, and 1B and the information communication systems 100 and 100A is realized by, for example, a computer that executes instructions of a program that is software realizing the foregoing functions. FIG. 9 illustrates an example of such a computer (hereinafter, referred to as “computer C”). The computer C includes at least one processor C1 and at least one memory C2. The memory C2 stores a program P for causing the computer C to function as each of the information communication apparatuses 1, 1A, and 1B and the information communication systems 100 and 100A. In the computer C, the processor C1 reads the program P from the memory C2 and executes the program P, so that the functions of the information communication apparatuses 1, 1A, and 1B and the information communication systems 100 and 100A are realized.

Examples of the processor C1 include a central processing unit (CPU), a graphic processing unit (GPU), a digital signal processor (DSP), a micro processing unit (MPU), a floating point number processing unit (FPU), a physics processing unit (PPU), a microcontroller, and a combination thereof. Examples of the memory C2 include a flash memory, a hard disk drive (HDD), a solid state drive (SSD), and a combination thereof.

Note that the computer C can further include a RAM in which the program P is loaded when the program P is executed and in which various kinds of data are temporarily stored. The computer C can further include a communication interface for carrying out transmission and reception of data with other apparatuses. The computer C can further include an input-output interface for connecting input-output apparatuses such as a keyboard, a mouse, a display and a printer.

The program P can be stored in a computer C-readable, non-transitory, and tangible storage medium M. The storage medium M can be, for example, a tape, a disk, a card, a semiconductor memory, a programmable logic circuit, or the like. The computer C can obtain the program P via the storage medium M. The program P can be transmitted via a transmission medium. The transmission medium can be, for example, a communication network, a broadcast wave, or the like. The computer C can obtain the program P also via such a transmission medium.

### Additional Remark 1

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

### Additional Remark 2

Some or all of the foregoing example embodiments can also be described as below. Note, however, that the present invention is not limited to the following supplementary notes.

### Supplementary Note 1

An information communication apparatus which is mounted on a target vehicle, the information communication apparatus including: a reception means for receiving a communication request message using wireless communication, the communication request message designating first identification information that identifies a second vehicle which is to be a communication partner of a first vehicle or a server apparatus; a determination means for determining, with reference to the first identification information, whether or not the target vehicle is the second vehicle to which a communication request is issued; and a transmission means for transmitting predetermined information possessed by the target vehicle to the first vehicle or the server apparatus in a case where the target vehicle is the second vehicle.

According to the above configuration, the first vehicle or the server apparatus transmits a communication request message that designates first identification information which identifies the second vehicle, and it is thus possible to carry out communication while identifying a vehicle of an intended condition.

### Supplementary Note 2

The information communication apparatus according to supplementary note 1, in which: the first identification information includes at least one item selected from the group consisting of license plate information, a vehicle type, and a body color of the second vehicle; and the determination means determines whether or not the target vehicle is the second vehicle based on whether or not at least one item of the first identification information conforms to preregistered information.

According to the above configuration, the first vehicle or the server apparatus transmits a communication request message that designates first identification information which represents a characteristic of the second vehicle, and it is thus possible to carry out communication while identifying a vehicle of an intended condition.

### Supplementary Note 3

The information communication apparatus according to supplementary note 1, in which: the first identification information is positional information of the second vehicle; and the determination means determines whether or not the target vehicle is the second vehicle based on whether or not positional information of the target vehicle conforms to the positional information of the second vehicle.

According to the above configuration, the first vehicle or the server apparatus transmits a communication request message that designates positional information of the second vehicle, and it is thus possible to carry out communication while identifying a vehicle of an intended condition.

### Supplementary Note 4

The information communication apparatus according to any one of supplementary notes 1 through 3, in which: the communication request message further includes second identification information pertaining to a behavior of the second vehicle; and the determination means determines whether or not the target vehicle is the second vehicle based on a combination of the first identification information and the second identification information.

According to the above configuration, it is possible to designate a vehicle of an intended condition in more detail.

### Supplementary Note 5

The information communication apparatus according to any one of supplementary notes 1 through 4, further including: an acceptance means for accepting selection by a user, in a case where the target vehicle is the second vehicle and the user has selected to accede to the communication request message, the transmission means transmitting the predetermined information possessed by the target vehicle, and in a case where the target vehicle is the second vehicle but the user has selected not to accede to the communication request message, the transmission means not transmitting the predetermined information possessed by the target vehicle.

According to the above configuration, a user of the target vehicle can decide whether or not to accede to the communication request message.

### Supplementary Note 6

The information communication apparatus according to any one of supplementary notes 1 through 5, in which: the predetermined information possessed by the target vehicle is communication connection information of the target vehicle in the wireless communication.

According to the above configuration, the first vehicle can carry out large-volume data communication with the target vehicle.

### Supplementary Note 7

The information communication apparatus according to any one of supplementary notes 1 through 5, in which: the predetermined information possessed by the target vehicle is sensing information which has been acquired by a sensing apparatus that is mounted on the target vehicle.

According to the above configuration, even in a case where there is a vehicle which obstructs sight in front of the first vehicle, it is possible to acquire information pertaining to the front of the vehicle which obstructs the sight.

### Supplementary Note 8

An information communication system, including: an information communication apparatus which is mounted on a target vehicle; a first transmission means for transmitting a communication request message using broadcast wireless communication, the communication request message designating first identification information that identifies a second vehicle which is to be a communication partner of a first vehicle or a server apparatus; a determination means for determining, with reference to the first identification information, whether or not the target vehicle is the second vehicle to which a communication request is issued; and a second transmission means for transmitting predetermined information possessed by the target vehicle to the first vehicle or the server apparatus in a case where the target vehicle is the second vehicle.

According to the above configuration, the first vehicle or the server apparatus transmits a communication request message that designates first identification information which identifies the second vehicle, and it is thus possible to carry out communication while identifying a vehicle of an intended condition.

### Supplementary Note 9

The information communication system according to supplementary note 8, in which: the first identification information includes at least one item selected from the group consisting of license plate information, a vehicle type, and a body color of the second vehicle; and the determination means determines whether or not the target vehicle is the second vehicle based on whether or not at least one item of the first identification information conforms to preregistered information.

According to the above configuration, the first vehicle or the server apparatus transmits a communication request message that designates first identification information which represents a characteristic of the second vehicle, and it is thus possible to carry out communication while identifying a vehicle of an intended condition.

### Supplementary Note 10

The information communication system according to supplementary note 8, in which: the first identification information is positional information of the second vehicle; and the determination means determines whether or not the target vehicle is the second vehicle based on whether or not positional information of the target vehicle conforms to the positional information of the second vehicle.

According to the above configuration, the first vehicle or the server apparatus transmits a communication request message that designates positional information of the second vehicle, and it is thus possible to carry out communication while identifying a vehicle of an intended condition.

### Supplementary Note 11

The information communication system according to any one of supplementary notes 8 through 10, wherein: the communication request message further includes second identification information pertaining to a behavior of the second vehicle; and the determination means determines whether or not the target vehicle is the second vehicle based on a combination of the first identification information and the second identification information.

According to the above configuration, it is possible to designate a vehicle of an intended condition in more detail.

### Supplementary Note 12

The information communication system according to any one of supplementary notes 8 through 11, further including: an acceptance means for accepting selection by a user, in a case where the target vehicle is the second vehicle and the user has selected to accede to the communication request message, the second transmission means transmitting the predetermined information possessed by the target vehicle, and in a case where the target vehicle is the second vehicle but the user has selected not to accede to the communication request message, the second transmission means not transmitting the predetermined information possessed by the target vehicle.

According to the above configuration, a user of the target vehicle can decide whether or not to accede to the communication request message.

### Supplementary Note 13

The information communication system according to any one of supplementary notes 8 through 12, in which: the predetermined information possessed by the target vehicle is communication connection information of the target vehicle in the wireless communication.

According to the above configuration, the first vehicle can carry out large-volume data communication with the target vehicle.

### Supplementary Note 14

The information communication system according to supplementary note 13, further including: a storage means for storing pieces of first identification information corresponding to respective vehicles included in a vehicle group and pieces of communication connection information of the respective vehicles in association with each other; a reception means for receiving a communication request message that designates a piece of first identification information which identifies the second vehicle; and a third transmission means for acquiring a piece of communication connection information corresponding to the second vehicle from the storage means and transmitting the piece of communication connection information to the first vehicle or the server apparatus in a case where the storage means stores a piece of first identification information included in the communication request message which has been received by the reception means.

According to the above configuration, the second transmission means does not need to transmit communication connection information to the first vehicle or the server apparatus, and this makes it possible to shorten a processing time.

### Supplementary Note 15

The information communication system according to supplementary note 14, in which: in a case where the storage means does not store the piece of first identification information included in the communication request message which has been received by the reception means, the third transmission means transfers the communication request message using broadcast wireless communication.

### Supplementary Note 16

The information communication system according to supplementary note 15, in which: the reception means receives, from the second vehicle, a piece of communication connection information corresponding to the second vehicle; and the storage means stores the piece of communication connection information corresponding to the second vehicle in association with the piece of first identification information which identifies the second vehicle.

### Supplementary Note 17

The information communication system according to any one of supplementary notes 8 through 12, in which: the predetermined information possessed by the target vehicle is sensing information which has been acquired by a sensing apparatus that is mounted on the target vehicle.

According to the above configuration, even in a case where there is a vehicle which obstructs sight in front of the first vehicle, it is possible to acquire information pertaining to the front of the vehicle which obstructs the sight.

### Supplementary Note 18

An information communication method, including: transmitting a communication request message using broadcast wireless communication, the communication request message designating first identification information that identifies a second vehicle which is to be a communication partner of a first vehicle or a server apparatus; determining, with reference to the first identification information, whether or not the target vehicle is the second vehicle to which a communication request is issued; and transmitting predetermined information possessed by the target vehicle to the first vehicle or the server apparatus in a case where the target vehicle is the second vehicle.

According to the above configuration, the first vehicle or the server apparatus transmits a communication request message that designates first identification information which identifies the second vehicle, and it is thus possible to carry out communication while identifying a vehicle of an intended condition.

### Supplementary Note 19

A program for causing a computer to carry out: a process of receiving a communication request message using wireless communication, the communication request message designating first identification information that identifies a second vehicle which is to be a communication partner of a first vehicle or a server apparatus; a process of determining, with reference to the first identification information, whether or not the target vehicle is the second vehicle to which a communication request is issued; and a process of transmitting predetermined information possessed by the target vehicle to the first vehicle or the server apparatus in a case where the target vehicle is the second vehicle.

According to the above configuration, the first vehicle or the server apparatus transmits a communication request message that designates first identification information which identifies the second vehicle, and it is thus possible to carry out communication while identifying a vehicle of an intended condition.

### Supplementary Note 20

An information communication apparatus including at least one processor, the at least one processor carrying out: a process of receiving a communication request message using wireless communication, the communication request message designating first identification information that identifies a second vehicle which is to be a communication partner of a first vehicle or a server apparatus; a process of determining, with reference to the first identification information, whether or not the target vehicle is the second vehicle to which a communication request is issued; and a process of transmitting predetermined information possessed by the target vehicle to the first vehicle or the server apparatus in a case where the target vehicle is the second vehicle.

Note that the information communication apparatus can further include a memory. The memory can store a program for causing the at least one processor to carry out the reception process, the determination process, and the transmission process. The program can be stored in a computer-readable non-transitory tangible storage medium.

### Supplementary Note 21

An information communication system including at least one processor, the at least one processor carrying out: a process of transmitting a communication request message using broadcast wireless communication, the communication request message designating first identification information that identifies a second vehicle which is to be a communication partner of a first vehicle or a server apparatus; a process of determining, with reference to the first identification information, whether or not the target vehicle is the second vehicle to which a communication request is issued; and a process of transmitting predetermined information possessed by the target vehicle to the first vehicle or the server apparatus in a case where the target vehicle is the second vehicle.

Note that the information communication system can further include a memory. The memory can store a program for causing the at least one processor to carry out the reception process, the determination process, the first transmission process, and the second transmission process. The program can be stored in a computer-readable non-transitory tangible storage medium.

### REFERENCE SIGNS LIST

1, 1A, 1B: Information communication apparatus
11, 24, 25: Reception means
12, 22: Determination means
13: Transmission means
14: Acceptance means
15, 26: Storage means
21: First transmission means
23: Second transmission means
27: Third transmission means
40, 60: Server apparatus
50: Sensing apparatus
100, 100A: Information communication system

What is claimed is:

1. An information communication apparatus which is mounted on a target vehicle, said information communication apparatus comprising at least one processor, the at least one processor carrying out:
a reception process of receiving a communication request message using wireless communication, the communication request message designating first identification information that identifies a second vehicle which is to be a communication partner of a first vehicle or a server apparatus;
a determination process of determining, with reference to the first identification information, whether or not the target vehicle is the second vehicle to which a communication request is issued; and
a transmission process of transmitting predetermined information possessed by the target vehicle to the first vehicle or the server apparatus in a case where the target vehicle is the second vehicle.

2. The information communication apparatus according to claim 1, wherein:
the first identification information includes at least one item selected from the group consisting of license plate information, a vehicle type, and a body color of the second vehicle; and
in the determination process, the at least one processor determines whether or not the target vehicle is the second vehicle based on whether or not at least one item of the first identification information conforms to preregistered information.

3. The information communication apparatus according to claim 1, wherein:
the first identification information is positional information of the second vehicle; and
in the determination process, the at least one processor determines whether or not the target vehicle is the second vehicle based on whether or not positional information of the target vehicle conforms to the positional information of the second vehicle.

4. The information communication apparatus according to claim 1, wherein:
the communication request message further includes second identification information pertaining to a behavior of the second vehicle; and
in the determination process, the at least one processor determines whether or not the target vehicle is the second vehicle based on a combination of the first identification information and the second identification information.

5. The information communication apparatus according to claim 1, wherein:
the at least one processor further carries out an acceptance means for process of accepting selection by a user;
in a case where the target vehicle is the second vehicle and the user has selected to accede to the communication request message, in the transmission process, the at least one processor transmits the predetermined information possessed by the target vehicle; and
in a case where the target vehicle is the second vehicle but the user has selected not to accede to the communication request message, in the transmission process, the at least one processor does not transmit the predetermined information possessed by the target vehicle.

6. The information communication apparatus according to claim 1, wherein:
the predetermined information possessed by the target vehicle is communication connection information of the target vehicle in the wireless communication.

7. The information communication apparatus according to claim 1, wherein:
the predetermined information possessed by the target vehicle is sensing information which has been acquired by a sensing apparatus that is mounted on the target vehicle.

8. An information communication system, comprising (i) an information communication apparatus which is mounted on a target vehicle; and (ii) at least one processor,
the at least one processor carrying out:
a first transmission process of transmitting a communication request message using broadcast wireless communication, the communication request message designating first identification information that identifies a second vehicle which is to be a communication partner of a first vehicle or a server apparatus;
a determination process of determining, with reference to the first identification information, whether or not the target vehicle is the second vehicle to which a communication request is issued; and
a second transmission process of transmitting predetermined information possessed by the target vehicle to the first vehicle or the server apparatus in a case where the target vehicle is the second vehicle.

9. The information communication system according to claim 8, wherein:
the first identification information includes at least one item selected from the group consisting of license plate information, a vehicle type, and a body color of the second vehicle; and
in the determination process, the at least one processor determines whether or not the target vehicle is the second vehicle based on whether or not at least one item of the first identification information conforms to preregistered information.

10. The information communication system according to claim 8, wherein:
the first identification information is positional information of the second vehicle; and
in the determination process, the at least one processor determines whether or not the target vehicle is the second vehicle based on whether or not positional information of the target vehicle conforms to the positional information of the second vehicle.

11. The information communication system according to claim 8, wherein:
the communication request message further includes second identification information pertaining to a behavior of the second vehicle; and
in the determination process, the at least one processor determines whether or not the target vehicle is the second vehicle based on a combination of the first identification information and the second identification information.

12. The information communication system according to claim 8, wherein:
the at least one processor further carries out an acceptance process of accepting selection by a user;
in a case where the target vehicle is the second vehicle and the user has selected to accede to the communication request message, in the second transmission process, the at least one processor transmits the predetermined information possessed by the target vehicle; and
in a case where the target vehicle is the second vehicle but the user has selected not to accede to the communication request message, in the second transmission process, the at least one processor does not transmit the predetermined information possessed by the target vehicle.

13. The information communication system according to claim 8, wherein:
the predetermined information possessed by the target vehicle is communication connection information of the target vehicle in the wireless communication.

14. The information communication system according to claim 13, wherein the at least one processor further carries out:
a storage process of storing, by a storage means, pieces of first identification information corresponding to respective vehicles included in a vehicle group and pieces of communication connection information of the respective vehicles in association with each other;
a reception process of receiving a communication request message that designates a piece of first identification information which identifies the second vehicle; and
a third transmission process of acquiring a piece of communication connection information corresponding to the second vehicle from the storage means and transmitting the piece of communication connection information to the first vehicle or the server apparatus in a case where the storage means stores a piece of first identification information included in the communication request message which has been received by in the reception process.

15. The information communication system according to claim 14, wherein:
in a case where the storage means does not store the piece of first identification information included in the communication request message which has been received by in the reception process, the at least one processor transfers, in the third transmission process, the communication request message using broadcast wireless communication.

16. The information communication system according to claim 15, wherein:
in the reception process, the at least one processor receives, from the second vehicle, a piece of communication connection information corresponding to the second vehicle; and
in the storage process, the at least one processor stores, in the storage means, the piece of communication connection information corresponding to the second vehicle in association with the piece of first identification information which identifies the second vehicle.

17. The information communication system according to claim 8, wherein:
the predetermined information possessed by the target vehicle is sensing information which has been acquired by a sensing apparatus that is mounted on the target vehicle.

18. (canceled)

19. A non-transitory storage medium storing a program for causing a computer to carry out:
a process of receiving a communication request message using wireless communication, the communication request message designating first identification information that identifies a second vehicle which is to be a communication partner of a first vehicle or a server apparatus;
a process of determining, with reference to the first identification information, whether or not the target vehicle is the second vehicle to which a communication request is issued; and
a process of transmitting predetermined information possessed by the target vehicle to the first vehicle or the server apparatus in a case where the target vehicle is the second vehicle.
